(19) United States
(12) Patent Application Publication
(10) Pub. No.: US 2009/0060343 A1
(43) Pub. Date: Mar. 5, 2009

(54) METHOD FOR PARTIALLY OBSCURING CONTENT OF DOCUMENTS AND IMAGES

(76) Inventor: Andrew Rosca, Stamford, CT (US)

Correspondence Address: Kristina M. Grasso;Kristina M. Grasso, Esq. PLLC, P.O. Box 162, Milford, NH, 03055, US

(21) Appl. No.: 12/194,524

(22) Filed: Aug. 19, 2008

Related U.S. Application Data
(60) Provisional application No. 60/969,161, filed on Aug. 30, 2007.

(51) Int. Cl. G06K 9/46

(52) U.S. Cl. 382/190

(57) ABSTRACT

A method for partially obscuring part of a document (or image) for the purpose of hiding the content of that document while still revealing portions of the document so that the nature and validity of the content can be determined.

### RELATED APPLICATIONS

This application claims the benefit of U.S. Provisional Application No. 60/969,161, filed Aug. 30, 2007.

### FIELD OF THE INVENTION

The invention relates to computer data security. More particularly, the invention relates to a method of partially obscuring part of a document or image while revealing some portions of the document or image so that the nature and validity of the content may be determined.

### BACKGROUND OF THE INVENTION

When two parties exchange documents or images, particularly electronic documents, it is sometimes necessary for one of the parties to verify that the content of the document is as expected, while the party providing the document has a need to keep the information secret until the exchange has taken place. For example, in an escrow transaction involving documents or images the first party must provide proof that the document it offers for sale is authentic and contains the information expected by the second party, but at the same time the first party would like to keep the content of the document secret from the second party until the transaction has completed. This situation is usually resolved by the use of an escrow agent. An escrow agent is a neutral third party that is trusted by both parties. The escrow agent receives the electronic file from the sending party and only transfers it to the receiving party once payment has been received by the sending party. However, this type of escrow arrangement is only successful if the agent is able to verify the authenticity of the electronic file.

Consider the following example: Party A want to buy an MP3 file from Party B. If Party A pays Party B up front, Party A has no guarantee that Party B will send the MP3 file. If, on the other hand, Party B sends Party A the file before receiving payment, Party A has no incentive to pay, because he already has the MP3 file.

In the MP3 example, say Party A is buying “Yellow Submarine” by the Beatles. Unless the escrow agent can confirm that the song they received is indeed “Yellow Submarine”, the escrow transaction is useless. In most cases, such a verification of the transferred file is hard to do automatically, especially if its content is only relevant to the two transacting parties. In other words, sometimes the escrow agent cannot verify that the receiving party is getting what they are supposed to get.

The solution to this problem is to let the receiving party verify the asset. In the MP3 example, if the receiving party could listen to the MP3 file, they could confirm that it is what they wanted. As mentioned above though, if the receiving party got the entire file up front, they would have no incentive to pay.

The solution would be for the escrow agent to send the receiving party random portions of the MP3 file that they can listen to, e.g. most of the file is static, but random portions of it are left unaltered so you can hear the original. It is important that the various original portions of the song are in random places, so that the sending party can't simply send a file that contains mostly static to begin with.

In another example, when two parties to a transaction sign a contract they may both want to have confirmation that the contract was also signed by the other party. The proposed method and system allows the parties to the transaction to upload an electronic version of the signed contract to a centralized server where neither party has access to the other party's file. However, both parties may review partial information about the file which is sufficient to confirm that the contract was indeed signed by the other party. Once both parties agree that the electronic document is as expected, the server releases the files to both parties.

In a different example, two individual members of an online dating site may want to exchange photos, but both parties are uncomfortable sending a photo to the other party before being certain they will receive the other party's photo. The system of the present invention allows both parties to upload their respective photos to a centralized, independent server, where they can both review a small portion of the photo to confirm that it is indeed a clear photograph of a person. Once both parties are satisfied and indicate so to the system, each can view the complete version of the other party's photo.

### SUMMARY OF THE INVENTION

The proposed invention offers a method for partially revealing the content of such a document to the second party while still keeping the majority of the information secret. The method is particularly applicable to electronic images exchanged over a computer network such as the Internet, but can also be applied to documents, such as contracts, transcripts and data, and audio files.

This method is applicable, for example, in escrow transactions where at least three parties are involved. Party A provides a document, Party B wishes to acquire said document and the information contained therein, and Party E, the escrow agent, facilitates the transaction between A and B. Party A provides the original document to E. E applies the method described in this invention to obscure most of the document so that party B can review the obscured document to verify that it is indeed the document it wishes to acquire, but cannot obtain the information contained in it at this stage. Once party B has confirmed the transaction and provides an exchange document, payment, or another form of compensation for the document, party E releases the original document to party B and transfer the payment or compensation to party A.

### BRIEF DESCRIPTION OF THE DRAWINGS

FIG. 1 is an example of an image file prior to being obscured by the method of the present invention.

FIG. 2 depicts the image of FIG. 1 after being obscured by one embodiment of the method of the present invention.

FIG. 3 depicts the image of FIG. 1 after being obscured by another embodiment of the method of the present invention.

FIG. 4 is an example of a text file prior to being obscured by the method of the present invention.

FIG. 5 depicts the image of FIG. 4 after being obscured by one embodiment of the method of the present invention.

FIG. 6 depicts the image of FIG. 4 after being obscured by another embodiment of the method of the present invention.

FIG. 7 depicts the image of FIG. 4 after being obscured by a further embodiment of the method of the present invention.

### DETAILED DESCRIPTION

Alternate embodiments of the invention will be described here, one applicable to images (including drawings and other types of graphic documents), one to text documents, and one to audio files. In each embodiment, the method is identical but there are subtle variations in how it is applied.

Case 1: Images

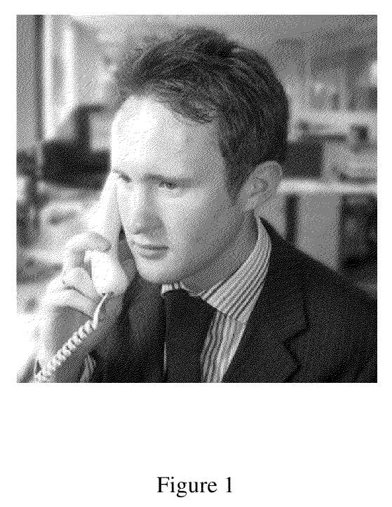

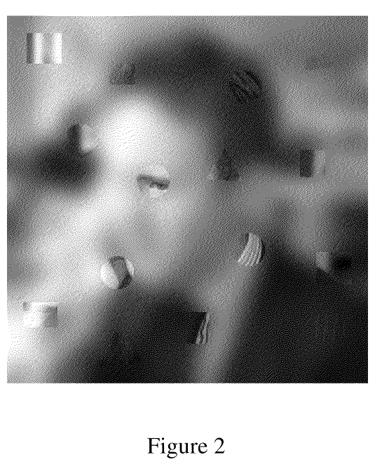

The method of the present invention is applied to the original image depicted in FIG. 1. As depicted in FIG. 2, the image is first blurred so that the content can be vaguely distinguished but not clearly identified. However, various portions of the original image are retained unchanged so that it is possible to verify that the original image is clear and contains appropriate information. The size, position, and shape of these areas are all random. This serves to eliminate the possibility for the party providing the image to purposely provide an original which is already blurred, except for the various areas that will be shown in clear in the obfuscated image.

There are many ways to blur an image, but at a basic level it always comes down to low-pass filtering of the image—this can be achieved in many ways, often by convolution of the image with a filter. Two types of filters are box filters and Gaussian filters. The Gaussian filter gives a “softer,” more aesthetically pleasing look. Algorithmically, the filtering process is achieved by calculating a weighted average of a cluster of source pixels for every destination pixel.

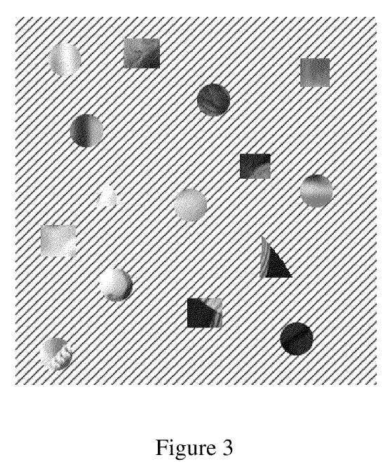

In a different embodiment, illustrated in FIG. 3, the image is overlaid with an opaque pattern, such as hash marks, that obscure most of the image so that the content can be vaguely distinguished but not clearly identified. As before, random areas of varying size, shape, and position are left unaltered. It is possible for this pattern to be semi-transparent so that the content of the image can still be vaguely distinguished, similar to a blurred image. Existing software, such as GoTalk® may be used to create the overlay image. Overlay cells can contain an image, text in any language (using Latin alphabet) or both. Multiple editing features let a user change color, size, font or text, and move, enlarge, rotate and crop images.

Case 2: Documents

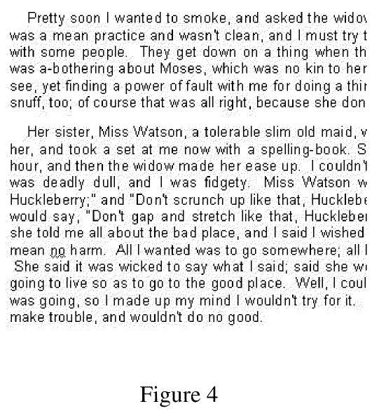

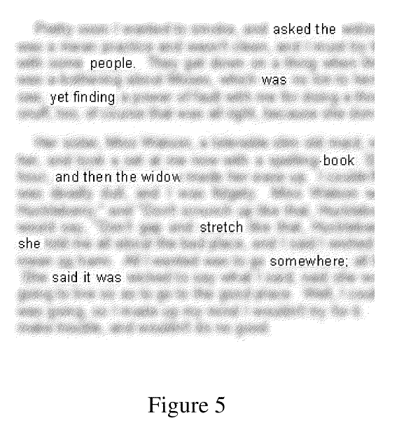

The method is applied to the original document depicted in FIG. 4. As seen in FIG. 5, the original document is first blurred so that the text contained therein cannot be read. Various words or groups of characters or partial words are left unaltered, visible and legible, so that the content of the document can be determined in part. The number and position of these words is random so that the party providing the original document has no knowledge of their position in the document and can thus not provided a document which contains no useful information except for these identification words. For example, a rogue party may provide a document in which all characters are the letter X except for the identification words. When blurred it would be impossible to tell that the document does not contain useful text. By randomly choosing words of groups of characters from the document such a scheme is thwarted since the rogue party would not know which words to leave intact. As with images, the text is blurred using a filter.

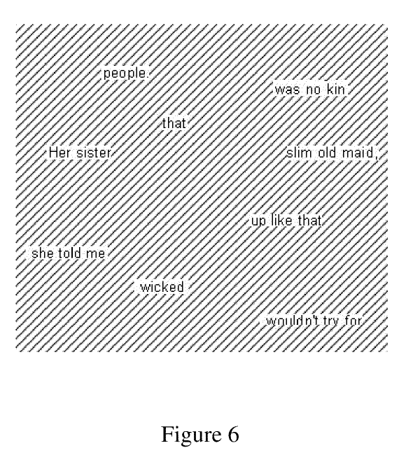

In a different embodiment of the present invention, shown in FIG. 6, the content of the document is obscured by an opaque pattern such as hash marks or another geometric or random pattern that does not allow the content to be read but obscures the content only in part, so that the presence of content can be determined. As discussed previously, random areas of the document are left visible and legible, i.e.: unobscured by the pattern. As with images, it is possible for the pattern to be semi-transparent and thus partially reveal the text below. As with images, the opaque pattern may be created using overlay software.

Alternatively, a watermark may be applied to the image to obscure portions of the image. The escrow agent may overlay a watermark or some other semi-transparent and/or opaque image, i.e.: a copyright notice, on top of the original image.

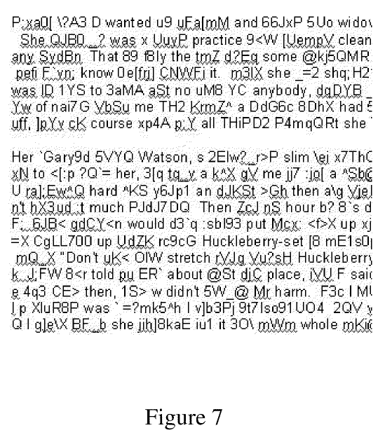

In yet another embodiment of the present invention, shown in FIG. 7, the majority of words or text in the document are replaced with random sequences of characters (“garbled” text) so that the content of the document cannot be read. As before, various random words are left unchanged so that the authenticity of the document can be verified. A computer program can easily produce random text using an algorithm, such as the Shannon-Fano algorithm.

Another program uses a technique that scans through the content of a block of text and creates a frequency table of what letters come after others. For example, after the letter “q” there will always be a “u”, but after an “e” there can be a range of letters—12 “r”, 14 “e”, 5 “l” and so on. The frequency table can cover different orders. 2nd order text is where 2 consecutive letters are matched, 3rd order is 3 consecutive letters, 4th order is 4 letters and so on. Text is then generated which is randomly produced but has the same distribution of letter groups as the input text. The result depends greatly on the source text and on the order. Technically, this process is based on Markov chains.

Case 3: Audio Files

The method of the present invention may be applied to audio files as well. The audio content is partially obscured with silence, static, or other sound that is not part of the original file so that the content can be vaguely distinguished but not clearly identified. However, various portions of the original audio file are retained unchanged so that it is possible to verify that the original audio content is clear and contains appropriate information. The size and location of these areas are all random.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

I claim:

1. A method for partially obscuring an image or document file for verification purposes comprising the steps of:
using a filter to blur a first portion of the image or document file wherein the first portion of the image or document file may be partially distinguished but not clearly identified;
retaining a second portion of the image or document file as unchanged for verification that the image or document file is clear and contains a desired piece of information.

2. The method of claim 1 wherein the first and second portions of the image or document file have a random size, number of pixels, number of words, position, and shape.

3. A method for partially obscuring an image, document, or audio file for verification purposes comprising the steps of:
overlaying a first portion of the image, document, or audio file with a pattern wherein the first portion of the image may be partially distinguished but not clearly identified;
retaining a second portion of the image, document, or audio file as unchanged for verification that the image, document, or audio file is clear and contains a desired piece of information.

4. The method of claim 3 wherein the pattern is selected from the group consisting of opaque, semi-transparent, static, silence, and a combination thereof.

5. The method of claim 3 wherein the first and second portions of the image, document or audio file have a random size, number of pixels, number of words, position, and shape.

6. A method for partially obscuring a plurality of text in a document for verification purposes comprising the steps of:
replacing a first section of the text in the document with a random sequence of characters so that the first section of the text of the document cannot be read.
retaining a second section of the text as unchanged for verification that the text is clear and contains a desired piece of information.
